(19) United States
(12) Patent Application Publication
(10) Pub. No.: US 2012/0260559 A1
(43) Pub. Date: Oct. 18, 2012

(54) STRUCTURE TO HIDE FEEDING STUFF INSIDE A FALSE FISH

(76) Inventor: Tsung-Hsi Tsai, Changhua City (TW)

(21) Appl. No.: 13/085,950

(22) Filed: Apr. 13, 2011

(51) Int. Cl. A01K 85/01

(52) U.S. Cl. 43/42.06

(57) ABSTRACT

A structure to hide feeding stuffs inside a false fish, whereof a chamber is provided at a proper location inside the false fish and several slots are installed inside the said chamber whose space is inset into by a container, the said container is installed with seeping holes and is installed with elastic locking pieces at its peripheral edge. When the container is inset into the chamber, the locking pieces are inserted into the said slots for positioning the container, so that feeding stuffs can be loaded inside the said container to drip slowly into the water through the seeping holes to attract fishes gathering so as to achieve the effect of seducing fishes to the hooks.

### BACKGROUND OF THE INVENTION

(a) Field of the Invention

The invention is related to a structure to hide feeding stuffs inside a false fish which is disclosed in that a chamber at a proper location is provided inside a false fish to allow for fitting a container inside the false fish.

(b) Description of the Prior Art

The conventional false fish is used as an auxiliary tool for fishing, the false fish is attached with several fishhooks and is painted with bright colors, whereof in the water, it swims around like a real fish to attract fishes to come near and to seduce the fishes to be hooked by the feeding stuffs on the fishhook.

### SUMMARY OF THE INVENTION

### I. Solutions to the Problems

1. The conventional false fish relies on its bright colors and feeding stuff on its fishhooks to attract fishes gathering and to promote the probability of fish hooking. However, as fishes are scattered in the vast underwater world, the fish gathering phenomenon is very hard to master, thereby it is difficult to get the fishes hooked.
2. In general, seducing fishes by using a false fish usually requires spraying a large quantity of fish feed stuffs around the angling position for cooperation; however most of the time, the fishes compete for the sprayed fish feeding stuffs rather than heeding the feeding stuffs on the fishhooks of the false fish; therefore, the fish seducing effect is not as good as expected.
3. If the false fish is used in sea angling, since sea water is always flowing, it is difficult to gather fishes, and even more difficult to hook the fishes.

### II. Method of Solutions

1. The invention discloses that a false fish is provided with a chamber at a proper location to allow a container to firmly inset into the space of the said chamber; at the same time, the said container is made with seeping holes, so that feeding stuffs can be loaded inside the said container to drip slowly into the water through the said seeping holes, thereby to attract fishes gathering and to promote the probability of hooking fishes.
2. The invention discloses that a chamber is installed at a proper location of the false fish and several slots are provided inside the chamber to allow for a container to inset into the space of the said chamber; at the same time, the said container is installed with seeping holes. Further, the peripheral edge of the container is installed with elastic locking pieces, when the container is inset into the chamber, the locking pieces are inserted into the said slots for positioning the container; thereby fish feeding stuffs can be loaded inside the said container to drip slowly into the water through the said seeping holes to attract fish gathering so as to achieve the effect of seducing fishes to the hook.
3. The container of the invention, whereof the front end of the said locking piece to inset into the slot and the rear end of the said locking piece to retreat from the slot are respectively made to an incline plane, whereby through utilizing the said incline planes, the container can be easily slipped in and slipped out of the chamber.

### BRIEF DESCRIPTION OF THE DRAWINGS

FIG. 1 is a 3D decomposition view of the invention.

FIG. 1A is a 3D view of the container of the invention.

FIG. 2 is a 3D assembly drawing of the invention.

FIG. 3 is a cross-sectional view of the false fish of the invention.

FIG. 4 is a cross-section status view of the invention showing that the container is inset into the chamber.

FIG. 5 is an embodying example cross-sectional view of the invention.

FIG. 6 is another embodying example of the invention showing a 3D decomposition view and a partial cross-sectional view.

### DETAILED DESCRIPTION OF THE PREFERRED EMBODIMENTS

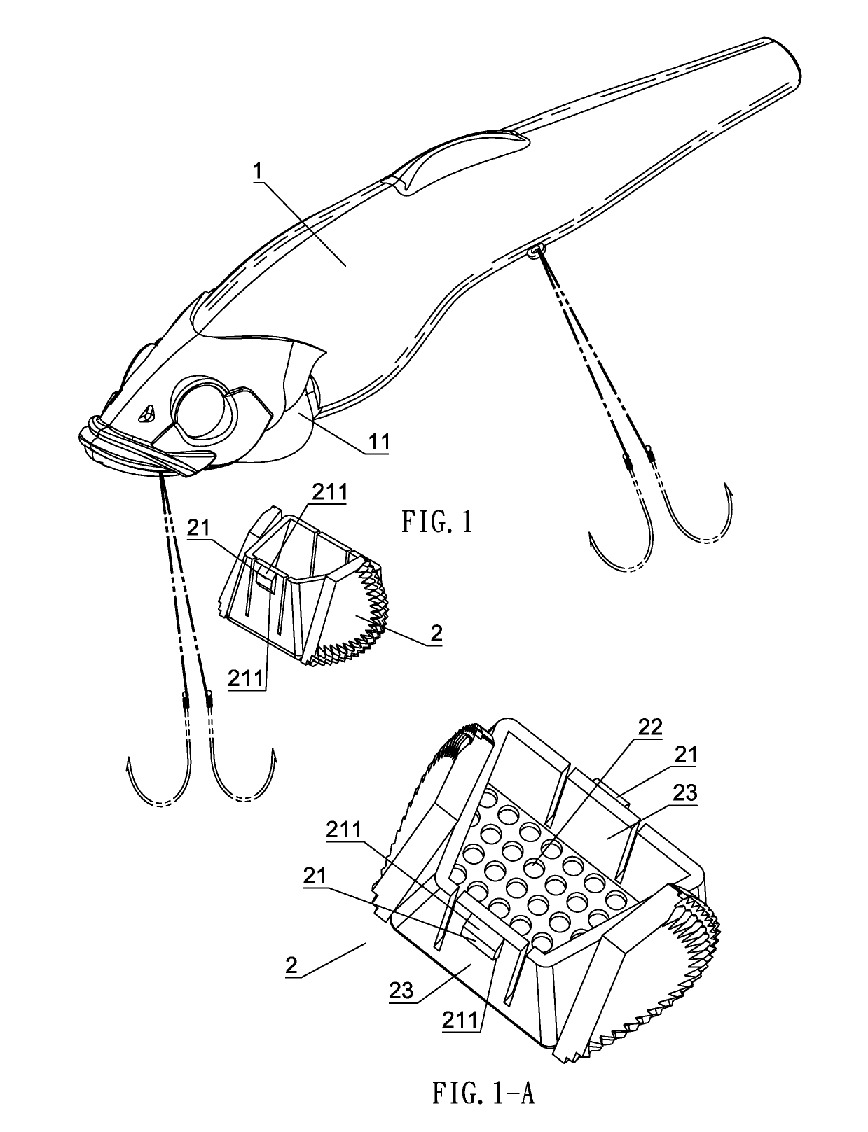

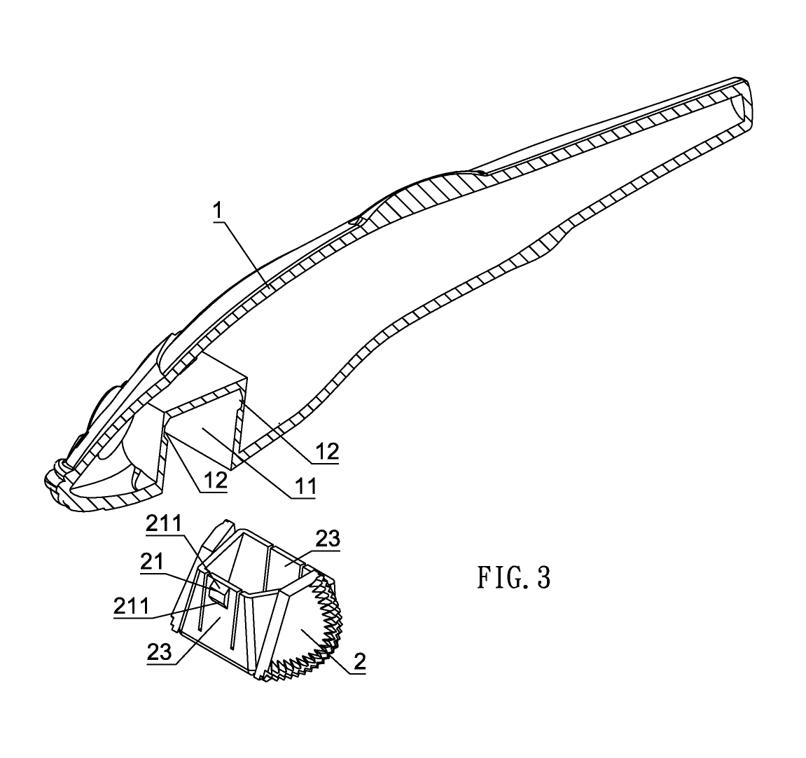

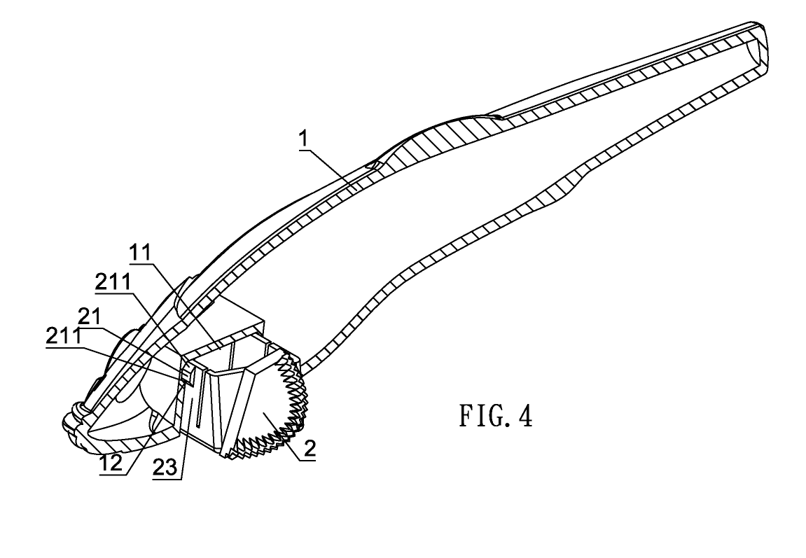

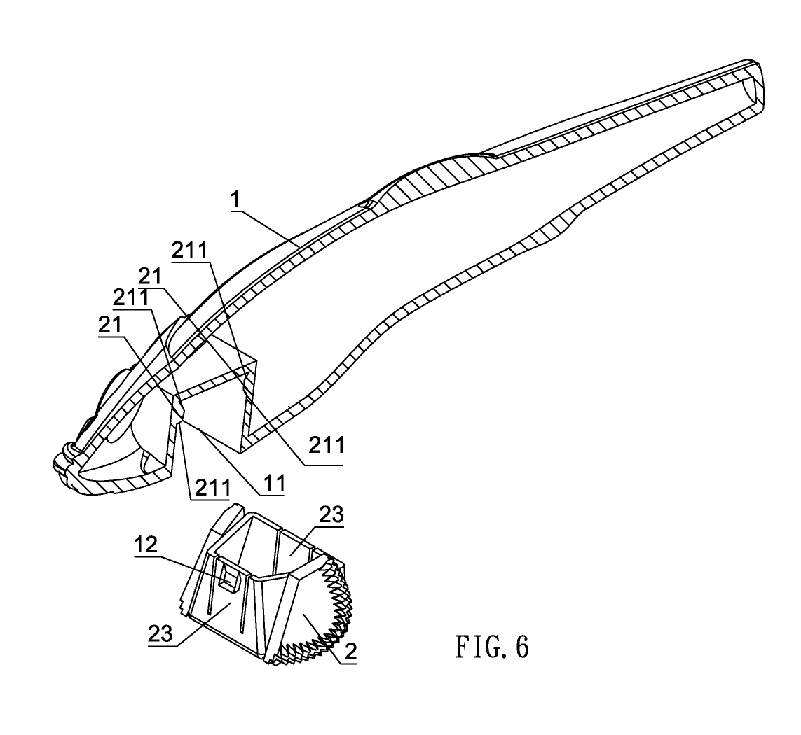

As shown in FIGS. 1, 1A, 2, 3, 4, 6, the false fish 1 is provided with a chamber 11 at a proper location and slots 12 or locking pieces 21 are installed inside the said chamber; the peripheral edge of a container 2 is installed with locking pieces 21 or slots 12 (as shown in FIGS. 3, 6) corresponding to the aforesaid slots 12 or locking pieces 21 to allow the said container 2 to firmly inset into the space of the said chamber 11 (as shown in FIG. 4); the said container 2 is made with seeping holes 22 so that feeding stuffs A can be loaded inside the said container 2 to drip slowly into the water through the said seeping holes 22, thereby to attract fishes gathering and to promote the probability of hooking fishes.

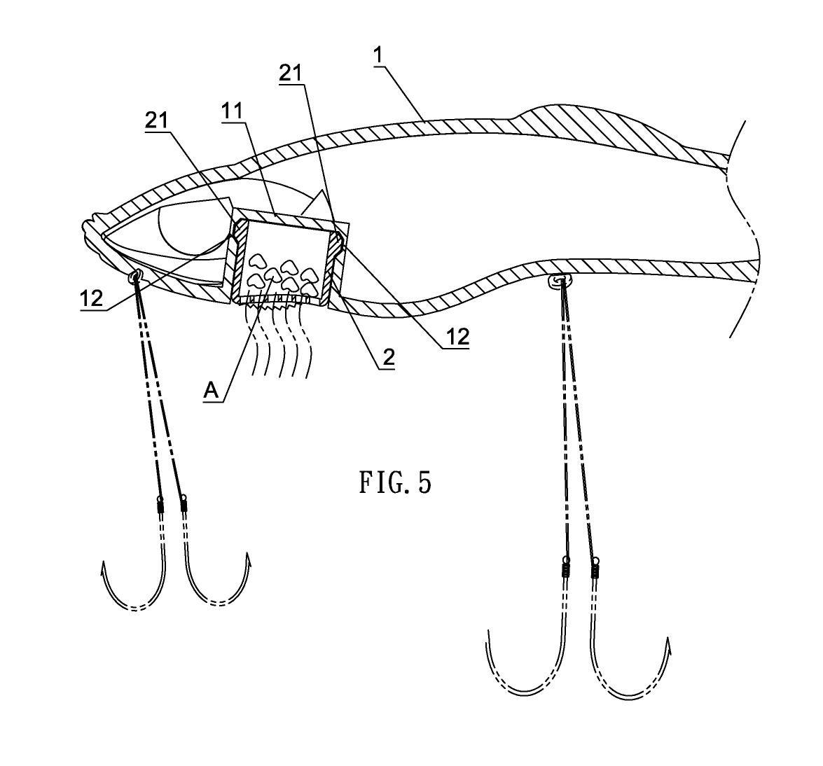

As shown in FIG. 1, FIG. 1A and FIG. 5, the false fish 1 is provided with a chamber 11 at a proper location and slots 12 are installed inside the said chamber for a container 2 to inset into the space of the said chamber 11; and the said container 2 is installed with seeping holes 22 (as shown in FIG. 1A). Further, the peripheral edge of the container 2 is installed with locking pieces 21 corresponding to positions of the slots 12 of the said chamber 11, whereby when the said container 2 is inset into the chamber 11, the locking pieces 11 are inserted into the slots 12 of the said chamber 11 to position the container more firmly, thereby fish feeding stuffs A can be loaded inside the said container 2 to drip slowly into the water through the said seeping holes 22 to attract fishes gathering so as to achieve the effect of seducing fishes to the hooks.

As shown in FIGS. 1A, 3 and 6, the peripheral edge of said container 2 is installed with at least one spring piece 23; the said spring piece 23 is installed with a locking piece 21 for insetting into the slots 12 of the said chamber 11; the front end of the locking piece 21 to inset into the slot 12 and the rear end of the locking piece 21 to retreat from the slot 12 are respectively made to an incline plane 211, so that when the said container 2 is inset into or retreated from the chamber 11, the spring piece 23 can be deformed easily through application of the incline planes 211, so that the container 2 can be slipped in and slipped out of the chamber more smoothly.

As shown in FIGS. 3 and 6, the aforesaid locking pieces 12 of the container 2 and slots 12 of the chamber 11 can be mutually interchanged to be slots 12 of the container 2 and locking pieces 21 of the chamber, while the effect of positioning container 2 into chamber 11 can also be achieved.

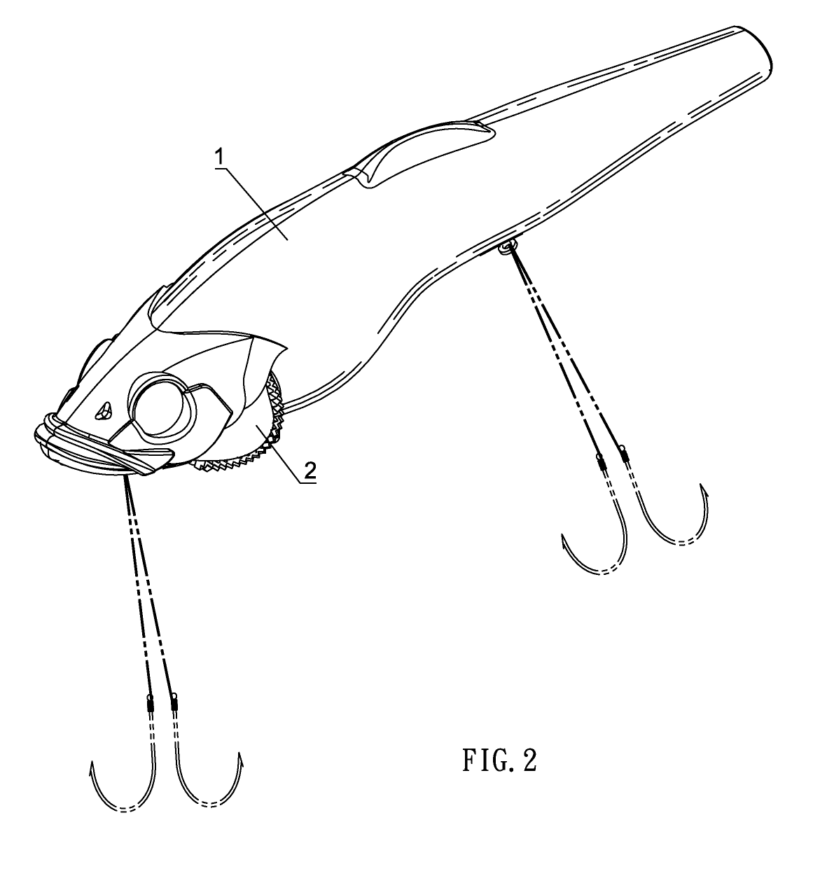

As shown in FIGS. 1 and 2, the outlook of the said container 2 can be matched with the position of the insetting chamber 11 to be incorporated in the overall outlook of the false fish to provide an integral appearance of the false fish.

1. A structure of hiding feeding stuffs inside a false fish which is characterized in that the false fish is provided with a chamber at a proper location and slots or locking pieces are installed inside the said chamber; the peripheral edge of a container is installed with locking pieces or slots corresponding to the said slots or locking pieces to allow the said container to firmly inset into the space of the said chamber; at the same time, the said container is made with seeping holes, so that feeding stuffs can be loaded inside the said container to drip slowly into the water through the said seeping holes, thereby to attract fishes gathering and to promote the probability of hooking fishes.

2. A structure to hide feeding stuffs inside a false fish which is characterized in that:
a chamber is installed at a proper location of the false fish and several slots are provided inside the chamber;
a container to inset into the space of the said chamber; at the same time, the said container is installed with seeping holes, the peripheral edge of the container is installed with locking pieces corresponding to positions of the several slots of the said chamber, whereby when the said container is inset into the chamber, the locking pieces are inserted into the slots of the said chamber to position the container;
thereby, fish feeding stuffs can be loaded inside the said container to drip slowly into the water through the said seeping holes to attract fishes gathering so as to achieve the effect of seducing fishes to the hooks.

3. The structure to hide feeding stuffs inside a false fish as in claim 1, in which the said container is installed with spring pieces, the said spring piece is installed with a locking piece which is inserted in and retreated out of the slot of the said container, and the spring piece is deformed for easy insertion and retreat.

4. The structure to hide feeding stuffs inside a false fish as in claim 3, in which the front end of the said locking piece to inset into the slot and the rear end of the said locking piece to retreat from the slot are respectively made to an incline plane, whereby through utilization of the said inclined planes, the container can be easily slipped in and slipped out of the chamber.

5. The structure to hide feeding stuffs inside a false fish as in claim 1, in which the locking piece installed at the peripheral edge of the said container and the slot installed inside the chamber have at least one and more than one corresponding pairs.

6. The structure to hide feeding stuffs inside a false fish as in claim 1, in which the locking pieces of the said container and the slots of the said chamber can be mutually interchanged to the slots of the said container and the locking pieces of the said chamber, while the effect of positioning container 2 into chamber 11 can also be achieved.

7. The structure to hide feeding stuffs inside a false fish as in claim 2, in which the outlook of the said container can be matched with the position of the insetting chamber to be incorporated in the overall outlook of the false fish to provide an integral appearance of the false fish.

8. The structure to hide feeding stuffs inside a false fish as in claim 2, in which the said container is installed with spring pieces, the said spring piece is installed with a locking piece which is inserted in and retreated out of the slot of the said container, and the spring piece is deformed for easy insertion and retreat.

9. The structure to hide feeding stuffs inside a false fish as in claim 8, in which the front end of the said locking piece to inset into the slot and the rear end of the said locking piece to retreat from the slot are respectively made to an incline plane, whereby through utilization of the said inclined planes, the container can be easily slipped in and slipped out of the chamber.

10. The structure to hide feeding stuffs inside a false fish as in claim 2, in which the locking piece installed at the peripheral edge of the said container and the slot installed inside the chamber have at least one and more than one corresponding pairs.

11. The structure to hide feeding stuffs inside a false fish as in claim 2, in which the locking pieces of the said container and the slots of the said chamber can be mutually interchanged to the slots of the said container and the locking pieces of the said chamber, while the effect of positioning container 2 into chamber 11 can also be achieved.
